(19) United States
(12) Patent Application Publication
(10) Pub. No.: US 2014/0215220 A1
(43) Pub. Date: Jul. 31, 2014

(54) APPLICATION DISTRIBUTION SYSTEM AND METHOD

(71) Applicant: Korea Internet & Security Agency, Seoul (KR)

(72) Inventors: Mi Joo KIM, Seoul (KR); Mi Yeon Yoon, Seoul (KR); Kyung Ho Son, Seoul (KR); Hae Ryong Park, Incheon (KR)

(73) Assignee: Korea Internet & Security Agency, Seoul (KR)

(21) Appl. No.: 14/052,173

(22) Filed: Oct. 11, 2013

(30) Foreign Application Priority Data
Jan. 31, 2013 (KR) 10-2013-0010953

(51) Int. Cl. H04L 9/32

(52) U.S. Cl. CPC H04L 9/3247
USPC 713/176

(57) ABSTRACT

The present invention relates to an application distribution system and method, and the application distribution system according to the present invention includes a developer terminal for requesting registration of an application; and an application trading server for registering and posting the application in an application store in response to the request of the developer terminal, in which if the application does not have an electronic signature, the application trading server performs security verification on the application based on preset application security verification criteria, generates an electronic signature for the application and transmits the electronic signature to the developer terminal, and if the application has an electronic signature, the application trading server performs security verification on the application by verifying the electronic signature.

### CROSS-REFERENCE TO RELATED APPLICATION

This application claims priority of Korean application number 10-2013-0010953 filed on Jan. 31, 2013, which is incorporated herein by reference in its entirety.

### FIELD OF THE INVENTION

The present invention relates to an application distribution system and method, and more specifically, to an application distribution system and method for verifying, registering and posting an application based on security verification criteria agreed among a plurality of application trading servers.

### BACKGROUND OF THE RELATED ART

Recently, as smart phones are distributed rapidly, interest in various applications that can be used in a smart phone is growing. Accordingly, smart phone manufacturers and mobile service providers operate application stores (hereinafter, referred to as ‘app stores’) for users to easily purchase a variety of applications operable in a smart phone.

The app store is operated such that if a developer develops and registers an application in the app store, a purchaser connects to the app store and downloads a desired application for free or paid.

According to such a conventional technique, since app stores verify applications based on different security criteria, security levels of circulated applications are different from one another. Therefore, if the app stores verify applications on less strict security criteria, unsafe applications can be circulated.

In addition, when a developer requests different app stores to register an application, each app store should independently verify security of the app, and thus it takes a long time to register the application, and the app stores should redundantly verify the application.

### SUMMARY OF THE INVENTION

Therefore, the present invention has been made in view of the above problems, and it is an object of the present invention to provide an application distribution system and method for verifying security of an application using application security verification criteria agreed among application trading service providers.

In addition, another object of the present invention to provide an application distribution system and method, in which each application trading server may sign an electronic signature on an application using a certificate unique to the server.

To accomplish the above objects, an application distribution system according to the present invention includes: a developer terminal for requesting registration of an application; and an application trading server for registering and posting the application in an application store in response to the request of the developer terminal, in which if the application does not have an electronic signature, the application trading server performs security verification on the application based on preset application security verification criteria, generates an electronic signature for the application and transmits the electronic signature to the developer terminal, and if the application has an electronic signature, the application trading server performs security verification on the application by verifying the electronic signature.

In addition, the developer terminal transmits a source code, an executable file and a specification of the application when the developer terminal requests registration of the application.

In addition, the developer terminal transmits a source code, an executable file, a specification and the electronic signature of the application when the developer terminal requests registration of the application.

In addition, the electronic signature is an electronic signature of another application trading server for the application.

In addition, the application trading server includes: a security verification unit for confirming whether or not the application satisfies the preset application security verification criteria by performing static and dynamic analysis on the source code and the executable file of the application; an electronic signature generation unit for generating the electronic signature by encrypting a hash value, which is generated by performing abash operation on the source code, using an electronic signature generation key of the application trading server; and an electronic signature verification unit for decrypting the electronic signature signed on the application using an electronic signature verification key of the application and confirming whether or not the decrypted value corresponds to the hash value generated by performing a hash operation on the source code of the application.

In addition, the preset application security verification criteria are security verification criteria agreed among application trading service providers in advance.

In addition, an application distribution method according to the present invention includes the steps of: requesting, by a developer server, an application trading server to register a developed application; performing, by the application trading server, security verification on the application based on preset application security verification criteria; generating, by the application trading server, an electronic signature for the application after performing security verification on the application; transmitting, by the application trading server, the electronic signature of the application to the developer terminal; requesting, by the developer server, another application trading server to register the application signed with the electronic signature; verifying, by the another application trading server, the electronic signature signed on the application; and registering and posting, by the another application trading server, the application signed with the electronic signature in an application store, if verification on the electronic signature is succeeded.

In addition, the application security verification step confirms whether or not the application satisfies the preset application security verification criteria by performing static and dynamic analysis on the source code and the executable file of the application.

In addition, the electronic signature generation step includes the steps of: generating a hash value by performing a hash operation on the source code of the application; and generating the electronic signature by encrypting the hash value using an electronic signature generation key of the application trading server.

In addition, the electronic signature verification step includes the steps of: decrypting the electronic signature using an electronic signature verification key of the application trading server; and confirming whether or not a value obtained by decrypting the electronic signature is the same as the hash value generated by performing a hash operation on the source code of the application.

### BRIEF DESCRIPTION OF THE DRAWINGS

FIG. 1 is a view showing the configuration of an application distribution system according to the present invention.

FIG. 2 is a block diagram showing the application trading server of FIG. 1.

FIG. 3 is a sequence diagram illustrating an application distribution method according to an embodiment of the present invention.

FIG. 4 is a sequence diagram illustrating an application distribution method according to another embodiment of the present invention.

### DETAILED DESCRIPTION OF THE PREFERRED EMBODIMENT

The preferred embodiments of the invention will be hereafter described in detail, with reference to the accompanying drawings.

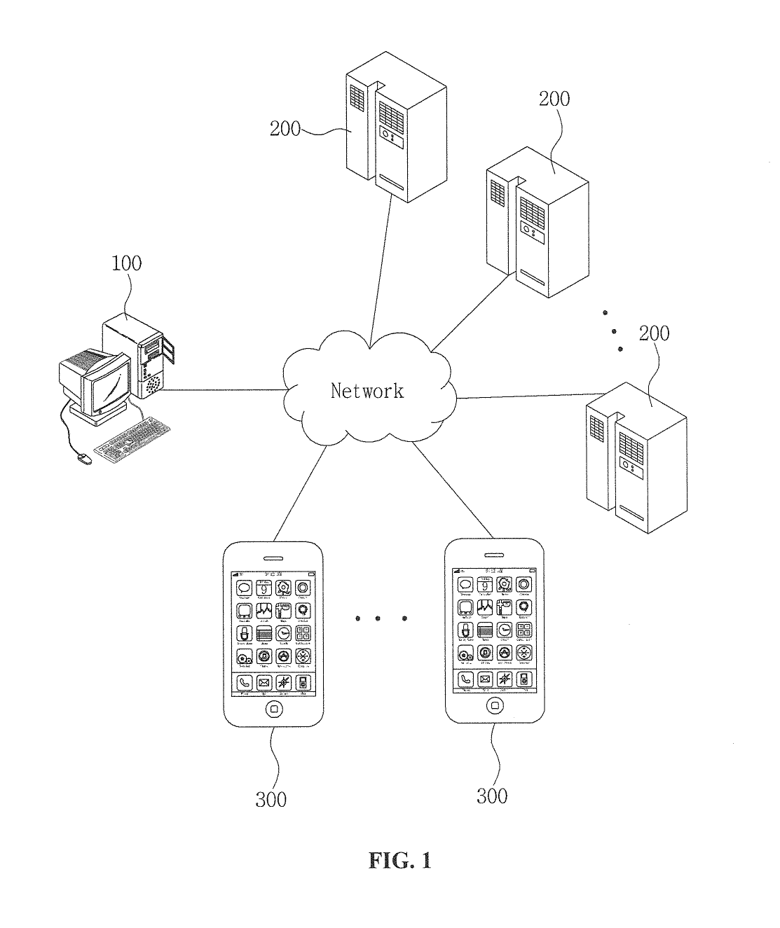

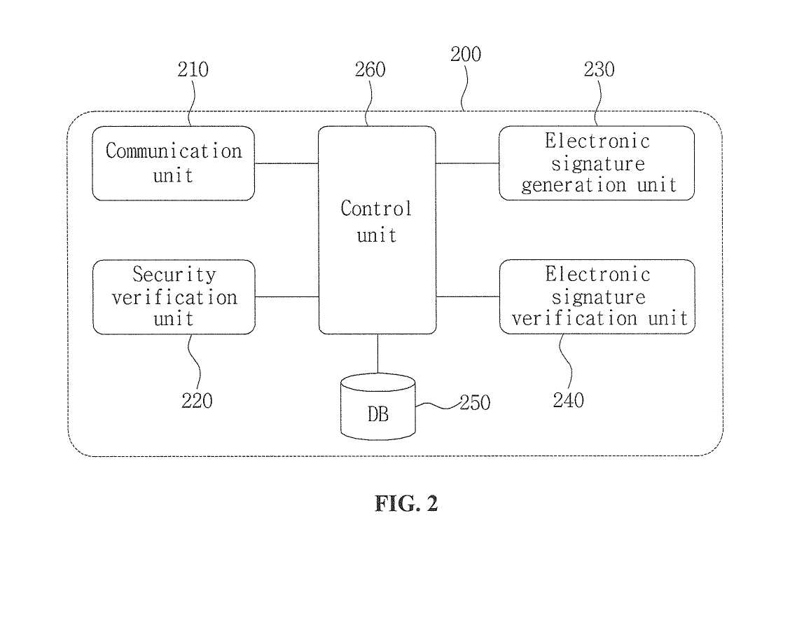

FIG. 1 is a view showing the configuration of an application distribution system according to the present invention, and FIG. 2 is a block diagram showing the application trading server of FIG. 1.

Referring to FIG. 1, the application distribution system according to the present invention includes a developer terminal 100, an application trading servers 200 and a user terminals 300 connected through a network. Here, a communication network such as a wired or wireless Internet network, a mobile communication network or a near field communication network is used as the network.

A source code, an executable file and a specification of an application (hereinafter, referred to as an app) developed by a developer are created at the developer terminal 100. Program development tools used for developing the application is installed in the developer terminal 100.

The developer terminal 100 connects to the application trading server 200 through the communication network and requests to register the developed app in an application store (app store) operated by the application trading server 200. The app store is an on-line mobile contents market place where mobile applications (contents application programs mounted on a mobile terminal, such as a schedule management program, an address book, an alarm program, a calculator, a game, a moving image, a music playback program, a navigation program, a word processor, Excel and the like) are freely traded, including the App Store of Apple Computer, the Android market of Google, the T Store of SK telecommunications, and the like.

The application trading server 200 registers the developed app in a database and posts the app in the app store (an application trading site) in response to the request of the developer terminal 100. The application trading server 200 includes a communication unit 210, a security verification unit 220, an electronic signature generation unit 230, an electronic signature verification unit 240, a database (DB) 250 and a control unit 260.

The application trading server 200 transmits and receives data to and from the developer terminal 100 and the user terminal 300 through the communication unit 210. The communication unit 210 is configured of a mobile communication module, a wired and wireless communication module and the like.

If an app registration request transmitted from the developer terminal 100 is received through the communication unit 210, the control unit 260 of the application trading server 200 confirms whether or not security verification is required for the app requested to be registered. That is, the control unit 260 confirms whether or not the app requested to be registered has an electronic signature.

If the app does not have an electronic signature, the control unit 260 controls the security verification unit 220 to perform security verification on the source code and the executable file of the app requested to be registered through static and dynamic analysis. At this point, the security verification unit 220 confirms whether or not the app requested to be registered satisfies application security verification criteria agreed with other application trading servers 200 in advance.

If the app requested to be registered satisfies the application security verification criteria, the electronic signature generation unit 230 generates a hash value by performing a hash operation on the source code of the app under the control of the control unit 230 and generates an electronic signature (certificate) by encrypting the hash value using an electronic signature generation key. Then, the application trading server 200 transmits the generated electronic signature to the developer terminal 100 through the communication unit 210. The application trading server 200 has an electronic signature generation key of its own used for generating the electronic signature and an electronic signature verification key used when other application trading servers 200 verify the electronic signature signed on the app.

If the app requested to be registered is an app that has passed security verification, the electronic signature verification unit 240 of the application trading server 200 verifies the electronic signature transmitted when the developer 100 requests registration of the app. In other words, if the app requested to be registered has an electronic signature, the application trading server 200 verifies the corresponding electronic signature.

The electronic signature verification unit 240 decrypts the electronic signature signed on the app requested to be registered using the electronic signature verification key of an application trading server 200 which first has performed the security verification on the app. Then, the electronic signature verification unit 240 confirms whether or not a decrypted value corresponds to the hash value generated by the hash operation performed on the source code of the app requested to be registered.

The control unit 260 registers the app requested to be registered in the database 250 and posts the app in an app store according to a result of the electronic signature verification output from the electronic signature verification unit 240. In other words, if the decrypted value (a hash value) corresponds to the hash value obtained by performing a hash operation on the source code of the app requested to be registered, the application trading server 200 registers the corresponding app in the database 250 and posts the app in an app store. On the other hand, if the decrypted value does not correspond to the hash value obtained by performing a hash operation on the source code of the app requested to be registered, the application trading server 200 feeds back this fact to the developer terminal 100.

In addition, if the user terminal 300 purchases a specific application through a wireless communication, the application trading server 200 transmits the corresponding application to the user terminal 300. In other words, the user terminal 300 connects to the app store, purchases a desired application, downloads the corresponding application and installs the application in the user terminal.

As described above, in the present invention, since the application trading server 200 performs app security verification only when an app developed by a developer is registered for the first time and, if the app security verification is succeeded, generates an electronic signature for the source code of the app using a certificate unique to the application trading server 200 and provides the electronic signature to the developer, the developer may sign a signature on the source code of the app using the provided electronic signature.

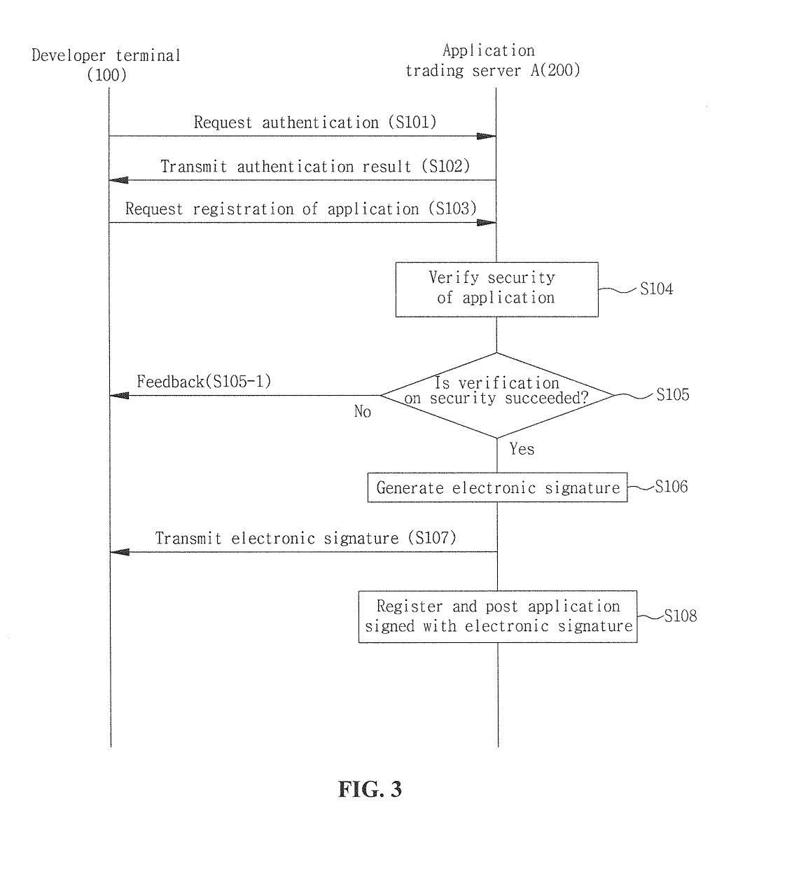

FIG. 3 is a sequence diagram illustrating an application distribution method according to an embodiment of the present invention. This embodiment describes, for example, a case of registering an app developed by a developer in an app store for the first time.

First, the developer terminal 100 requests user authentication from the application trading server 200 S101. At this point, the developer terminal 100 transmits an ID and a password of a developer as identification information.

The application trading server 200 confirms whether or not the ID and the password transmitted from the developer terminal 100 are registered in the database 250 and informs the developer terminal 100 of a result of the authentication S102. That is, the application trading server 200 transmits a result of the authentication to the developer terminal 100.

When the authentication process is completed, the developer terminal 100 requests the application trading server 200 to register an application (app) developed by the developer S103. At this point, the developer terminal 100 transmits a request message including a source code, an executable file and a specification of the app.

The application trading server 200 performs security verification on the application requested to be registered, based on preset app security verification criteria S104. That is, the security verification unit 220 performs security verification on the app transmitted from the developer terminal 100 based on the app security verification criteria agreed among application trading service providers in advance.

If security of the application meets the app security verification criteria, the application trading server 200 generates an electronic signature of the application trading server 200 for the application requested to be registered S106. The electronic signature generation unit 230 of the application trading server 200 generates a hash value by performing a hash operation on the source code of the app and then generates the electronic signature by encrypting the generated hash value using an electronic code generation key unique to the application trading server 200. That is, the electronic signature generation unit 230 signs an electronic signature on the source code of the app.

Then, the application trading server 200 transmits the generated electronic signature to the developer terminal 100 through the communication unit S107.

After transmitting the generated electronic signature, the application trading server 200 registers and posts the application signed with the electronic signature in an app store operated by the application trading server 200 S108.

On the other hand, if the security verification on the app requested to be registered is failed at step S105, the control unit 260 of the application trading server 200 transmits a result thereof to the developer terminal 100 S105-1. In other words, if the app requested to be registered does not meet the preset app security verification criteria, the application trading server 200 feeds back a notification message informing the fact to the developer terminal 100.

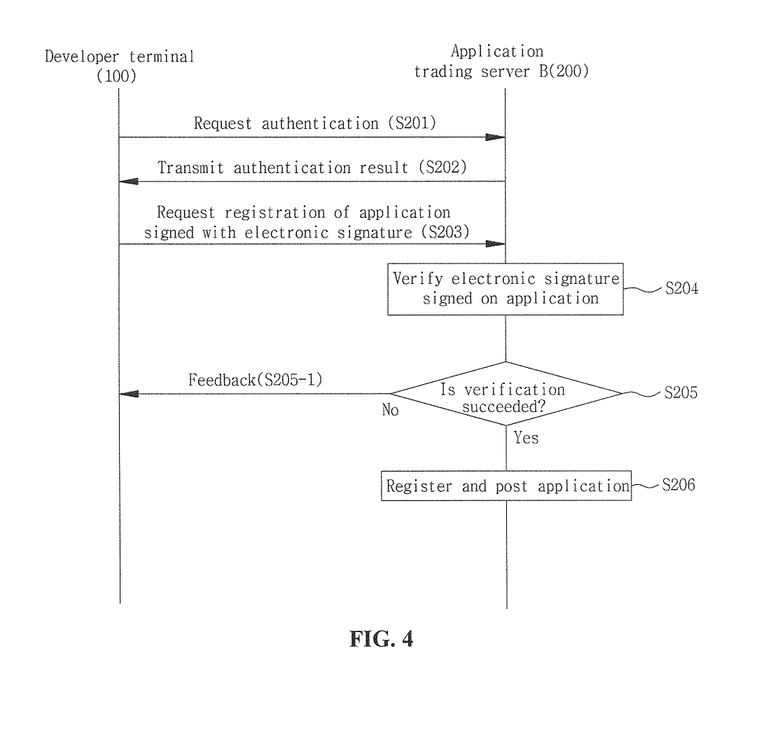

FIG. 4 is a sequence diagram illustrating an application distribution method according to another embodiment of the present invention. This embodiment describes a case of registering an app developed by a developer in another app store after performing security verification on the app.

As shown in FIG. 4, the developer terminal 100 connects to the application trading server 200 in which an app will be registered and passes through a user authentication procedure S201 and S202.

The developer terminal 100 requests the application trading server 200 to register the app that has passed the security verification of the application trading server 200 S203. At this point, the developer terminal 100 transmits a source code, an executable file and a specification of the app when the developer terminal 100 transmits a registration request message. If the request for registration of the app is received from the developer terminal 100, the application trading server 200 confirms whether or not an electronic signature is contained in the app requested to be registered.

The application trading server 200 verifies the electronic signature signed on the app 8204. In other words, the app requested to be registered by the developer terminal 100 contains an electronic signature, the application trading server 200 verifies the electronic signature signed on the app through the electronic signature verification unit 204. Like this, the present invention confirms whether or not security verification has been performed on the app by verifying the electronic signature signed on the app.

If verification on the electronic signature is succeeded, the application trading server 200 registers and posts the corresponding app in an app store S205 and S206.

On the other hand, if the electronic signature is not verified, the application trading server 200 feeds back a verification result informing failure of the electronic signature verification to the developer terminal 100 S205-1.

The present invention allows only applications satisfying application security verification criteria agreed among application trading service providers in advance to be posted in an app store so that applications which guarantees security of a certain level may be circulated, and thus security of the applications can be improved.

Furthermore, from the aspect of an application developer, the present invention may reduce a time required for application security verification in the case of posting the application in different app stores and reduce a time required for registering and posting the application after the application is developed.

Furthermore, from the aspect of an app store, the present invention may save cost such as an effort or a time required for redundantly verifying an application.

Furthermore, the present invention allows a user to use only safe applications which is verified to be secure.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An application distribution system comprising:
a developer terminal for requesting registration of an application; and
an application trading server for registering and posting the application in an application store in response to the request of the developer terminal, wherein
if the application does not have an electronic signature, the application trading server performs security verification on the application based on preset application security verification criteria, generates an electronic signature for the application and transmits the electronic signature to the developer terminal, and if the application has an electronic signature, the application trading server performs security verification on the application by verifying the electronic signature.

2. The system according to claim 1, wherein the developer terminal transmits a source code, an executable file and a specification of the application when the developer terminal requests registration of the application.

3. The system according to claim 1, wherein the developer terminal transmits a source code, an executable file, a specification and the electronic signature of the application when the developer terminal requests registration of the application.

4. The system according to claim 3, wherein the electronic signature is an electronic signature of another application trading server for the application.

5. The system according to claim 1, wherein the application trading server includes:
a security verification unit for confirming whether or not the application satisfies the preset application security verification criteria by performing static and dynamic analysis on the source code and the executable file of the application;
an electronic signature generation unit for generating the electronic signature by encrypting a hash value, which is generated by performing a hash operation on the source code, using an electronic signature generation key of the application trading server; and
an electronic signature verification unit for decrypting the electronic signature signed on the application using an electronic signature verification key of the application and confirming whether or not the decrypted value corresponds to the hash value generated by performing a hash operation on the source code of the application.

6. The system according to claim 5, wherein the preset application security verification criteria are security verification criteria agreed among application trading service providers in advance.

7. An application distribution method comprising the steps of:
requesting, by a developer server, an application trading server to register a developed application;
performing, by the application trading server, security verification on the application based on preset application security verification criteria;
generating, by the application trading server, an electronic signature for the application after performing security verification on the application;
transmitting, by the application trading server, the electronic signature of the application to the developer terminal;
requesting, by the developer server, another application trading server to register the application signed with the electronic signature;
verifying, by the another application trading server, the electronic signature signed on the application; and
registering and posting, by the another application trading server, the application signed with the electronic signature in an application store, if verification on the electronic signature is succeeded.

8. The method according to claim 7, wherein the application security verification step confirms whether or not the application satisfies the preset application security verification criteria by performing static and dynamic analysis on a source code and an executable file of the application.

9. The method according to claim 7, wherein the electronic signature generation step includes the steps of:
generating a hash value by performing a hash operation on the source code of the application; and
generating the electronic signature by encrypting the hash value using an electronic signature generation key of the application trading server.

10. The method according to claim 7, wherein the electronic signature verification step includes the steps of:
decrypting the electronic signature using an electronic signature verification key of the application trading server; and
confirming whether or not a value obtained by decrypting the electronic signature is the same as a hash value generated by performing a hash operation on the source code of the application.
